(19) United States
(12) Patent Application Publication
(10) Pub. No.: US 2015/0135867 A1
(43) Pub. Date: May 21, 2015

(54) SWING TYPE POWER DOOR LOCK MOTOR

(71) Applicant: Taiger International Corp., New Taipei City (TW)

(72) Inventor: Li CHENG, New Taipei City (TW)

(73) Assignee: Taiger International Corp., New Taipei City (TW)

(21) Appl. No.: 14/082,015

(22) Filed: Nov. 15, 2013

(51) Int. Cl. F16H 19/08

(52) U.S. Cl. CPC F16H 19/08
USPC 74/89.23

(57) ABSTRACT

A swing type power door lock motor includes a housing having mounted therein a drive unit, which includes a motor, a transmission unit, which includes a screw shaft connected to the motor and a transmission seat threaded onto the screw shaft, and a swing unit, which includes a sector gear meshed with the transmission seat and a swing arm connected to the sector gear. When the motor is started, the screw shaft is driven to move the transmission seat, causing the sector gear to bias the swing arm between a locking position and an unlocking position.

### BACKGROUND OF THE INVENTION

1. Field of the Invention

The present invention relates to a central car door locking system, and mare particularly, to a swing type power door lock motor.

2. Description of the Related Art

Currently, all cars are equipped with a central door locking system for controlling the locking and unlocking of all the car doors to enhance driver and passenger safety and convenience. Conventional central control car door lock systems (or power door lock actuators) are generally divided into the push-pull type and the swing type. A push-pull type actuator uses an actuating bar (or rod) to push and pull mechanical car door locks between the locking position and the unlocking position. A swing type actuator uses a single swing arm to swing, thereby driving mechanical car door locks between the locking position and the unlocking position. For the advantages of high actuating force, low failure rate and small size for easy installation, swing type actuator has gradually become the standard equipment of major car manufacturing companies.

U.S. Pat. No. 5,441,315 discloses an electric-motor drive for motor-vehicle central lock system, which uses a reversible electric motor to drive an input gear, thereby biasing a support of biasing means. When the support of the biasing means is being biased, a coupling gear is forced into engagement with an output gear, driving the output gear to rotate a threaded output spindle, and thus a out is forced to move along the threaded output spindle. During movement of the out along the threaded output spindle, an actuating element is forced by the nut to move a latch between two positions, thereby locking or unlocking the mechanical our door locks. According to this design, when the motor is started up, the rotary driving force must be transmitted through the biasing means for rotating the threaded spindle. The arrangement of the biasing means complicates the structure. Further, any minor installation error of the biasing means can affect the transmission performance. Further, transmission between the nut and the swing arm is achieved by means of matching between a circular block and a U-shaped groove. This arrangement can cause operation inaccuracy of the swing arm due to a manufacturing or installation error. In other words, this prior art patent has the drawbacks of complicated structure, installation difficulty and high failure rate.

### SUMMARY OF THE INVENTION

The present invention has been accomplished under the circumstances in view. It is the main object of the present invention to provide a swing type power door lock motor, which has the characteristics of simple structure, precision trans of gearing, smooth actuation and small size for easy installation.

To achieve this and other objects of the present invention, a swing type power door lock motor of the invention includes a housing, a drive unit, a transmission unit and swing unit. The housing comprises two opposing inner slide rails. The drive unit is mounted inside the housing, comprising a motor having a motor shaft. The transmission unit is mounted inside the housing, comprising a screw shaft and a transmission seat. The screw shaft has one end thereof coupled to the motor. The transmission seat is slidably set between the two inner slide rails and threaded onto the screw shaft, comprising a toothed rack. The swing unit comprises a sector gear and at least one swing arm. The sector gear is pivotally mounted in the housing. The sector gear comprises a tooth-bearing face meshed with the toothed rack of the transmission unit. The at least one swing arm is disposed outside the housing, each having one end thereof connected to the sector gear.

In one embodiment of the present invention, a micro switch is mounted inside the housing and electrically connected to the motor through a control module. When a trigger push block of the transmission seat pushes a trigger lever of the micro switch, the control module controls the motor to stop rotating.

In one embodiment of the present invention, the transmission seat comprises two outer rails respectively disposed at two opposite lateral sides thereof. Further, the inner slide rails of the housing are respectively coupled to the outer rails of the transmission seat to enhance moving stability of the transmission seat.

In one embodiment of the present invention, the housing comprises a ridge-shaped protruding portion located on an outer perimeter thereof, and an arched recessed portion disposed adjacent to the ridge-shaped protruding portion. Further, the sector gear comprises an axle pivotally connected to the ridge-shaped protruding portion of the housing. Further, the swing arm has one end thereof fixedly connected to the axle of the sector gear by a connection member. Further, the center of axis of the connection member is kept in a coaxial relationship relative to the center of the arched recessed portion to increase the swing angle of the swing arm, thereby enhancing the operation accuracy.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is an devotional view of a swing type power door lock motor in accordance with a first embodiment of the present invention.

FIG. 2 is a sectional elevation view of the first embodiment of the present invention, illustrating the internal structure of the swing type power door lock motor.

FIG. 3 is a sectional side view of the swing type power door lock motor in accordance with the first embodiment of the present invention.

FIG. 4 is a sectional front view of the first embodiment of the present invention, illustrating the swing arm in the unlocking position.

FIG. 5 is similar to FIG. 4, illustrating the swing arm in the locking position.

FIG. 6 is a schematic front view of a part of the first embodiment of the present invention, illustrating the relationship between the sector gear and the e swing arms.

FIG. 7 is a block diagram of the first embodiment of the present invention, illustrating the relationship among the micro switch, the control module and the motor.

FIG. 8 is a schematic front view of a part of a swing type power door lock motor in accordance with a second embodiment of the present invention, illustrating a swing arm in an unlocking position.

FIG. 9 is similar to FIG. 8, illustrating the swing arm in a locking position.

### DETAILED DESCRIPTION OF THE INVENTION

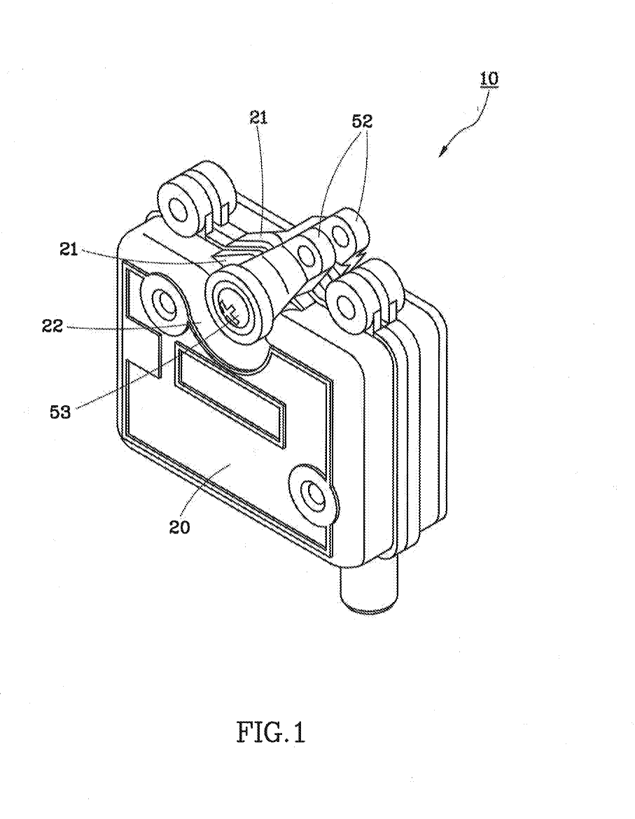

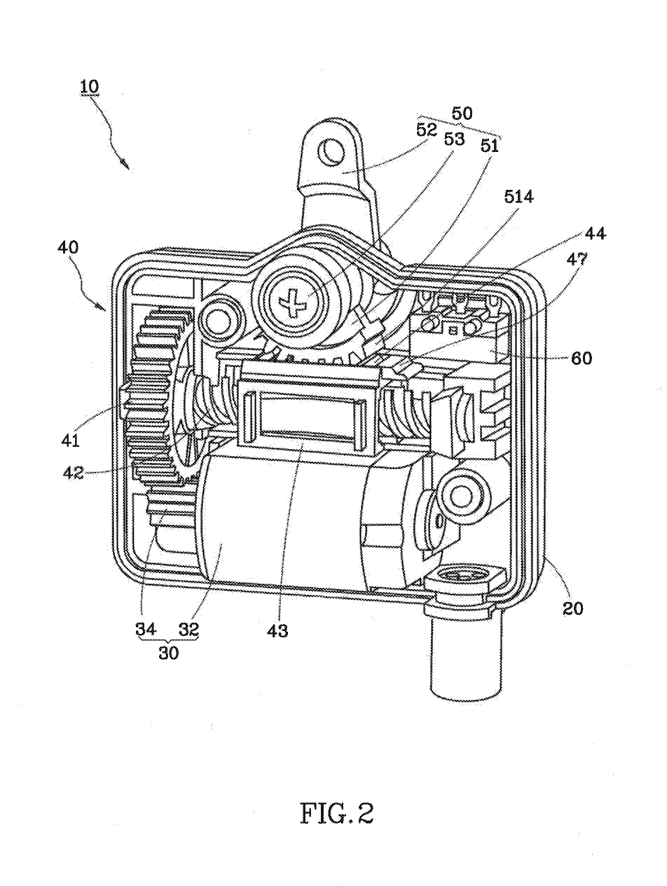

Referring to FIGS. 1 and 2, a swing type power door lock motor 10 in accordance with the present invention is shown comprising a housing 20, a drive unit 30, a transmission unit 40, and a swing unit 50.

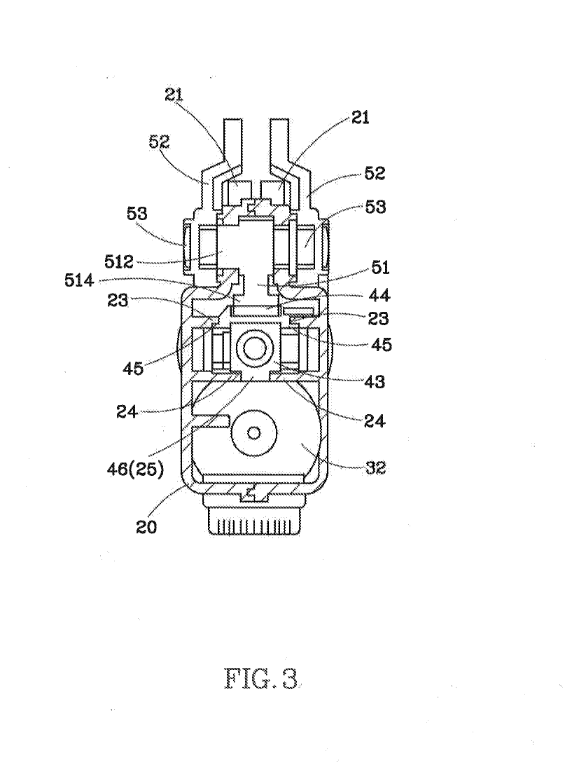

The housing 20 comprises two adjacent ridge-shaped protruding portions 21 and two opposite arched recessed portions 22 at the outer perimeter thereof. The two ridge-shaped protruding portions 21 are disposed between the two arched recessed portions 22. Thus, the ridge-shaped protruding portions 21 and the arched recessed portions 22 are adjacently arranged in an inner-outer relationship. Further, as shown in FIG. 3, the housing 20 has two opposing inner slide rails 23 and two opposing extension portions 24 located on an inside wall thereof, wherein the two extension portions 23 define therebetween a guide groove 25 that extends in a parallel manner relative to the inner slide rails 23.

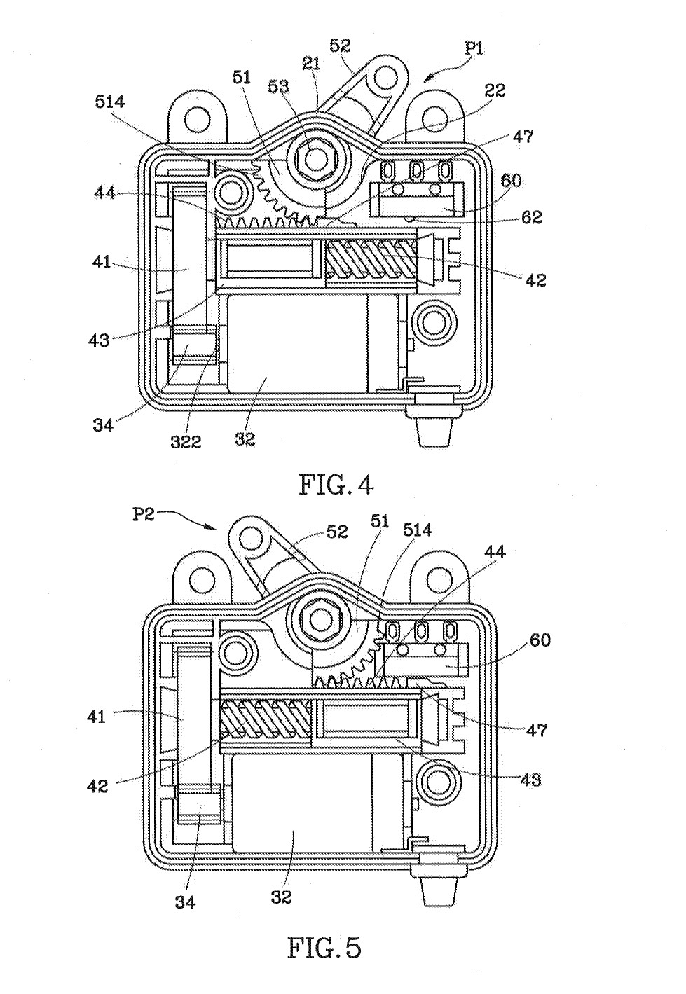

Referring to FIG. 4 and FIG. 2 again, the drive unit 30 is mounted inside the housing 20, comprising a motor 32 and a drive gear 34. The motor 32 comprises a motor shaft 322. The drive gear 34 is fixedly mounted on and rotatable by the motor shaft 322 of the motor 32.

Referring to FIGS. 2 and 4 again, the transmission unit 40 is mounted inside the housing 20, comprising a transmission gear 41, a screw shaft 42 and a transmission seat 43. The transmission gear 41 is meshed with the drive gear 34 of the drive unit 30 so that the transmission gear 41 is rotatable by the drive gear 34. The screw shaft 42 has one end thereof connected to the transmission gear 41 so that the screw shaft 42 is synchronously rotatable with the transmission gear 41. Further, the screw shaft 42 extends axially in a parallel manner relative to the motor shaft 322 of the motor 32. The transmission seat 43 is threaded onto the screw shaft 42 so that the transmission seat 43 is movable along the length of the screw shaft 42 during rotation of the screw shaft 42. Preferably, the transmission seat 43 is designed to have a rectangular configuration, avoiding rotation with the screw shaft 42 during displacement. Further, as shown in FIG. 3, the transmission seat 43 comprises two outer rails 45 respectively located at opposing left and right sides thereof and respectively coupled to the inner slide rails 23 of the housing 20, a guide block 46 located at a bottom side thereof and inserted into the guide groove 25 of the housing 20 to enhance sliding stability during sliding movement of the transmission seat 43, a toothed rack 44 located at a top side thereof, and a trigger push block 47 adjoined to one end of the toothed rack 47. The toothed rack 44 can be formed integral with the transmission seat 43. Alternatively, the toothed rack 44 can be a separated member affixed to the transmission seat 43. Preferably, the toothed rack 44 is an attached member.

For controlling the operation stroke of the motor 32 accurately, a micro switch 60 is mounted in the housing 20, as shown in FIGS. 2 and 4. The micro switch 60 is electrically connected to a control module 70 that is electrically coupled with the motor 32. Further, the micro switch 60 comprises a trigger lever 62. Thus, when the trigger push block 47 of the transmission seat 43 is moved with the transmission seat 43 to push the trigger lever 62 of the micro switch 60, the micro switch 60 will be triggered to output a signal to the control module 70, causing the control module 70 to stop the motor 32, as shown in FIG. 7.

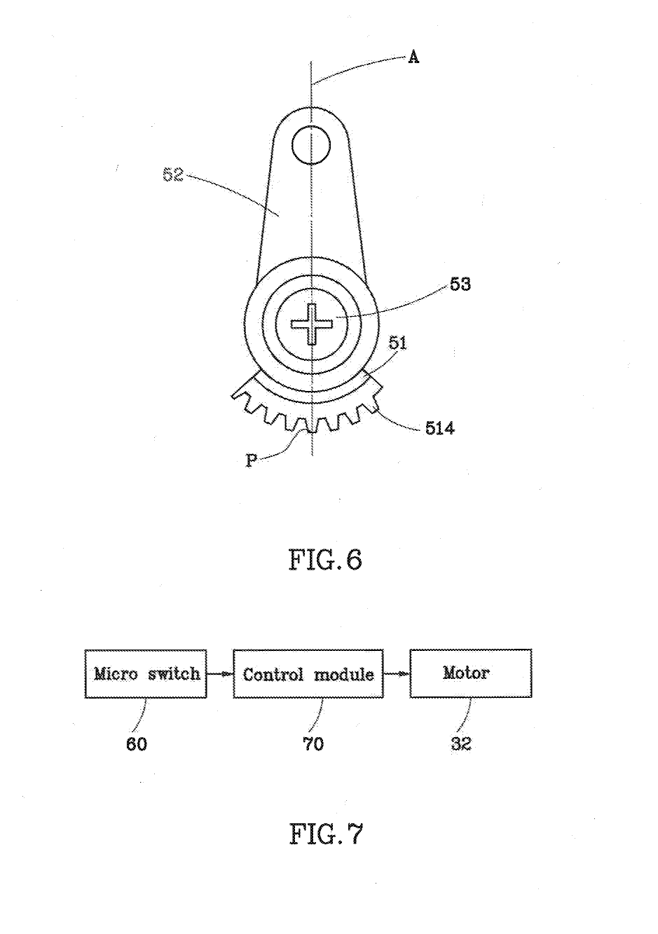

Referring to FIGS. 1, 2 and 4 again, the swing unit 50 comprises a sector gear 51 and two opposing swing arms 52. The sector gear 51 is pivotally mounted in the housing 20, comprising a tooth-bearing face 514 for engagement with the toothed rack 44 of the transmission unit 40. Further, as shown in FIG. 3, the sector gear 51 comprises an axle 512 pivotally mounted in the ridge-shaped protruding portions 21 of the housing 20 for enabling the sector gear 51 to be rotated by the toothed rack 44. The swing arms 52 are mounted on the outside of the housing 20. One swing arm 52 has its one end fixedly connected to a car door mechanical lock (not shown). The other swing arm 52 has its one end fixedly connected to a car door handle (not shown). The other ends of these two swing arms 52 are respectively fixedly connected to the axle 512 of the sector gear 51 by a respective connection member 53. The center of axis of each connection member 53 is kept in coaxial relationship with the centers of the arched recessed portions 22 of the housing 20, as shown in FIGS. 1 and 4. Further, each swing arm 52 extends along an axis line A in direction away from the sector gear 51. The extending direction of the axis line A passes through the point of bisection P of the tooth-bearing face 514 of the sector gear 51, as shown in FIG. 6. Thus, every swing arm 52 will he biased with the sector gear 51 to move the car door mechanical locks and the car door handles between an unlocking position P1 and a locking position P2, enhancing the safety and convenience of the use of the car.

Referring to FIGS. 4 and 5, when the motor 32 is started with the forward mode, the drive gear 34 will drive the transmission gear 41 to rotate the screw shaft 42 on its own axis in the forward direction. At this time, the transmission seat 43 will be forced to move forward along the length of the screw shaft 42. During the forward movement of the transmission seat 43, the sector gear 51 will be driven by the toothed rack 44 of the transmission seat 43 to bias the swing arms 52 toward the locking position P2. Once the trigger push block 47 of the transmission seat 43 pushes the trigger lever 62 of the micro switch 60, the control module 70 immediately controls the motor 32 to stop rotating subject to the signal provided by the micro switch 60, preventing motor overtravel. At this time, every swing arm 52 will stay in the locking position P2, enabling the car door mechanical locks and the car door handles to complete the locking action all together. On the contrary, when the motor 32 is started with the backward mode, the drive gear 34 will drive the transmission gear 41 to rotate the screw shaft 42 on its own axis in the reversed direction. At this time, the transmission seat 43 will be forced to move backward along the length of the screw shaft 42. During the backward movement of the transmission seat 43, the sector gear 51 will be driven by the toothed rack 44 of the transmission seat 43 to bias the swing arms 52 from the locking position P2 toward the unlocking position P1. When the swing arms 52 reach the unlocking position P1, the motor 32 will automatically stop rotating according to its own stroke setting, enabling the car door mechanical locks and the car door handles to complete the unlocking action all together.

We know from the above description, the swing type power door lock motor 10 of the present invention utilizes the feature of direct engagement between the drive gear 34 and the transmission gear 41 to rotate the screw shaft 42, and the feature of direct engagement between the toothed rack 44 of the transmission seat 43 and the sector gear 51 to bias the swing arms 52 between the locking position P2 and the unlocking position P1 during rotation of the screw shaft 42. When compared to the prior art patent, the present invention not only simplifies the configuration of the overall structure to enhance the ease of installation, but also enhances the operation smoothness and reduces the failure rate. Further, the pivot points of the swing arms 52 (i.e., the locations of the connection members 53) are disposed outside the housing 20 in a coaxial manner relative to the centers of the arched recessed portions 22 of the housing 20, and, the two connection members 53 are connected between the sector gear 51 and the swing arms 52 in a 180° phase angle relationship. When compared with the prior art patent where the pivot points of the swing arms are disposed inside the housing, the size of the housing 20 of the present invention can he properly reduced, invention to achieve the effect of compact. Further, the swing arms 52 of the present invention can produce a relatively larger swing angle to enhance the operation accuracy Therefore, the swing type power door lock motor 10 of the present invention can indeed achieve the objects of simple structure, precision trans of gearing, smooth actuation and small size for easy installation.

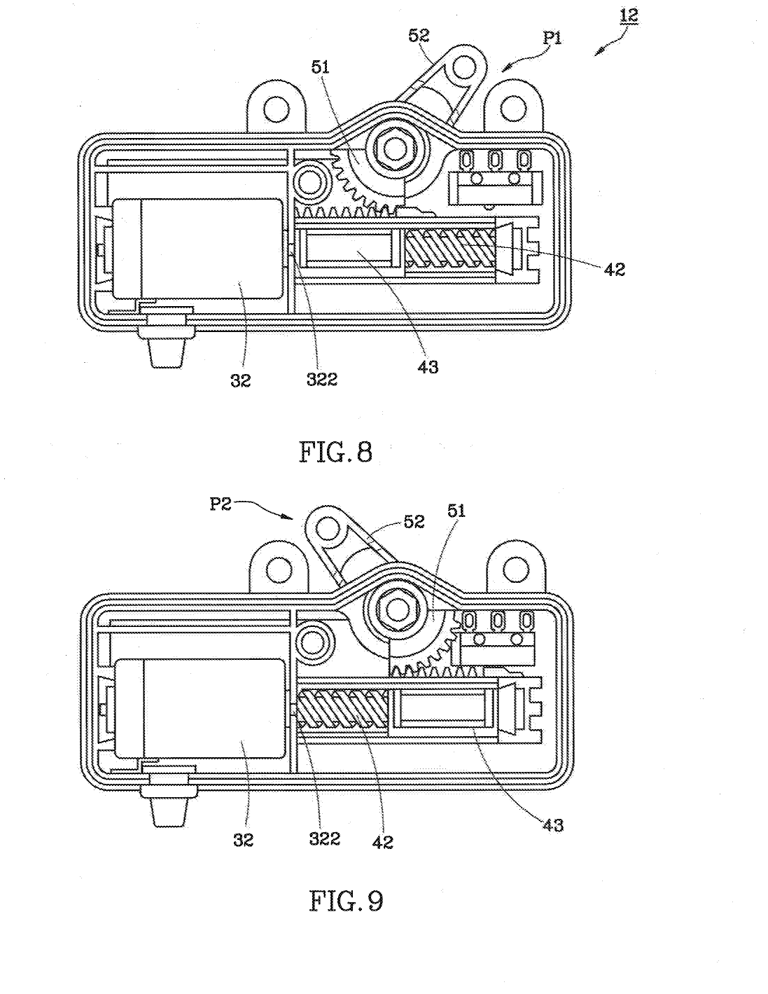

Further, the structure of the present invention can be variously embodied. As shown in FIGS. 8 and 9, a swing type power door lock motor 12 in accordance with a second embodiment of the present invention is shown. This second embodiment is substantially similar to the aforesaid first embodiment with the exception that the drive gear 34 and the transmission gear 41 are eliminated in this second embodiment, and then the motor shaft 322 of the motor 32 is directly connected with the screw shaft 42. Thus, when the motor 32 is started, the screw shaft 42 can be directly rotated by the motor 32, causing the transmission seat 43 to move forward or backward along the length of the screw shaft 42. During forward or backward movement of the transmission seat 43 along the length of the screw shaft 42, the swing arms 52 are biased between the locking position P2 and the unlocking position P1 subject to the relationship of engagement between the transmission seat 43 and the sector gear 51. Thus, the structural configuration of this second embodiment can achieve the same effects of the aforesaid first embodiment.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A swing type power door lock motor, comprising:
a housing comprising two opposing inner slide rails;
a drive unit mounted inside said housing, said drive unit comprising a motor having a motor shaft;
a transmission unit mounted inside said housing, said transmission unit comprising a screw shaft and a transmission seat, said screw shaft having one end thereof coupled to said motor, said transmission seat being slidably set between said two inner slide rails and threaded onto said screw shaft, said transmission seat comprising a toothed rack; and
a swing unit comprising a sector gear and at least one swing arm, said sector gear being pivotally mounted in said housing, said sector gear comprising a tooth-bearing face meshed with said toothed rack of said transmission unit, said at least one swing arm being disposed outside said housing, each said swing arm having one end thereof connected to said sector gear.

2. The swing type power door lock motor as claimed in claim 1, wherein said drive unit further comprises a drive gear fixedly connected to the motor shaft of said motor; said transmission unit further comprises a transmission gear meshed with said drive gear and fixedly connected to said screw shaft.

3. The swing type power door lock motor as claimed in claim 1, wherein said housing has a micro switch mounted therein and electrically connected to said motor, said micro switch comprising a trigger lever; said transmission seat comprises a trigger push block disposed adjacent to said toothed rack and adapted for pushing said trigger lever of said micro switch.

4. The swing type power door lock motor as claimed in claim 1, wherein said housing further comprises two opposing extension portions extended from an inside wall thereof and defining therebetween a guide groove; said transmission seat comprises a guide block slidably coupled to said guide groove of said housing.

5. The swing type power door lock motor as claimed in claim 1, wherein said transmission seat further comprises two outer rails respectively disposed at two opposite lateral sides thereof and respectively coupled to said inner slide rails of said housing.

6. The swing type power door lock motor as claimed in claim 1, wherein said housing further comprises at least one ridge-shaped protruding portion located on an outer perimeter thereof and at least one arched recessed portion disposed adjacent to said at least one ridge-shaped protruding portion; said sector gear comprises an axle pivotally connected to said at least one ridge-shaped protruding portion of said housing; each said swing arm has one end thereof fixedly connected to said axle of said sector gear by a connection member thereof, the center of axis of said connection member being kept in a coaxial relationship relative to the center of each said arched recessed portion.

7. The swing type power door lock motor as claimed in claim 6, wherein said toothed-bearing face of said sector gear defines a point of bisection; each said swing arm extends from said connection member along an axis line in direction away from said sector gear, the extending direction of said axis line passes through said point of bisection of said tooth-bearing faced of said sector gear.

8. The swing type power door lock motor as claimed in claim 6, wherein said housing comprises two said ridge-shaped protruding portions and two said arched recessed portions; said swing unit comprises two said swing arms, said two swing arms each having one end thereof respectively connected to said axle of said sector gear by one respective said connection member.

9. The swing type power door lock motor as claimed in claim 7, wherein said housing comprises two said ridge-shaped protruding portions and two said arched recessed portions; said swing unit comprises two said swing arms, said two swing arms each having one end thereof respectively connected to said axle of said sector gear by one respective said connection member.

10. The swing type power door lock motor as claimed in claim 1, wherein said motor shaft of said motor extends axially in a parallel relationship relative to the extending direction of said screw shaft.

11. The swing type power door lock motor as claimed in claim 1, wherein said transmission seat is a rectangular member.
